(19) United States
(12) Patent Application Publication
(10) Pub. No.: US 2013/0074690 A1
(43) Pub. Date: Mar. 28, 2013

(54) METHOD FOR OPERATION OF DUST COLLECTION DEVICE, AND DUST COLLECTION DEVICE

(71) Applicants: Kazutaka Tomimatsu, Kobe-shi (JP); Masaya Kato, Kobe-shi (JP); Akiyoshi Namba, Kobe-shi (JP); Yasutoshi Ueda, Tokyo (JP)

(72) Inventors: Kazutaka Tomimatsu, Kobe-shi (JP); Masaya Kato, Kobe-shi (JP); Akiyoshi Namba, Kobe-shi (JP); Yasutoshi Ueda, Tokyo (JP)

(21) Appl. No.: 13/700,925

(22) PCT Filed: May 30, 2011
(86) PCT No.: PCT/JP2011/062389

§ 371 Date: Nov. 29, 2012

(30) Foreign Application Priority Data
Jun. 2, 2010 (JP) 2010-127137

(51) Int. Cl. B03C 3/80; B03C 3/017

(52) U.S. Cl. CPC B03C 3/80; B03C 3/0175
USPC 95/26; 95/70; 96/18

(57) ABSTRACT

A method for operating a dust collection device by reducing the adhesion of high-resistance dust while performing stable charging, with minimal pressure loss and high efficiency. The dust collection device comprises a pre-charging unit and a bag filter in a flue gas duct through which a gas flows, with the pre-charging unit disposed upstream from the bag filter, wherein the pre-charging unit comprises electrodes that charge the dust, a power source that supplies electric power to the electrodes, and a gas flow rate control device that adjusts the flow rate of the gas flowing through the pre-charging unit to a prescribed value. The method comprises a step of charging the dust by applying a voltage from the electrodes to the dust, and a step of removing the dust adhered to the electrodes by increasing the flow rate of the gas flowing through the pre-charging unit.

### TECHNICAL FIELD

The present invention relates to a dust collection device that removes dust contained within a gas, and a method for operating the device.

### BACKGROUND ART

Conventionally, bag filters comprising a filter cloth have been installed for removing dust (particulate matter) contained within gases. Examples of the gases include the exhaust gases generated upon combustion of coal or fuel oil, and air. The aforementioned bag filters are installed within the flue gas ducts of industrial combustion facilities such as coal-burning and fuel oil-burning power generation plants and incinerators, and are also installed in the vicinity of devices that generate dust, for use as dust collection devices that collect environmental dust.

A pre-charging unit is sometimes installed in the flue gas duct upstream from the bag filter. The pre-charging unit comprises a charging unit composed of a discharge electrode and a grounding electrode which generates a corona discharge that imparts a positive or negative charge to the dust within the gas, causing cohesion and coarsening of the dust. The coarsened dust generated by this electrostatic cohesion is trapped on the surface of the filter cloth in the subsequent bag filter, thus forming a dust layer. Formation of this dust layer causes low pressure loss, and fine particles cohere to the coarse particles. Accordingly, clogging of the bag filter is reduced, and the coarse particles can be removed easily during backwashing. As a result, increases in the bag filter pressure loss can be suppressed.

On the other hand, dust also adheres to the grounding electrode, forming a dust layer. As this dust layer accumulates, a voltage effect occurs within the dust layer, causing a decrease in the discharge current. Moreover, if the dielectricity of the dust layer is broken, then a back discharge phenomenon occurs in which a charge of the reverse polarity (positive in the case of negative charging) is discharged from the grounding electrode. This phenomenon inhibits charging of the dust, resulting in a dramatic reduction in the charging efficiency.

Generally, in order to maintain stable charging, it is essential not only to prevent this back discharge phenomenon, but also to employ an electrode cleanup technique. Accordingly, a hammering mechanism is provided in the pre-charging unit, and the dust adhered to the electrode is removed periodically by hammering the electrode.

Patent Literature 1 (PTL 1) discloses a pre-charging device comprising two or more pre-charging chambers provided in parallel with the direction of gas flow. In the pre-charging device of PTL 1, when the back discharge phenomenon occurs in the pre-charging chamber that is performing charging, the gas flow path is switched to a pre-charging chamber capable of performing normal charging, thus enabling dust charging to be continued. Following switching of the gas flow path, the dust inside the pre-charging unit in which the back discharge phenomenon has occurred is shaken loose, thus restoring the pre-charging chamber.

### CITATION LIST

Patent Literature

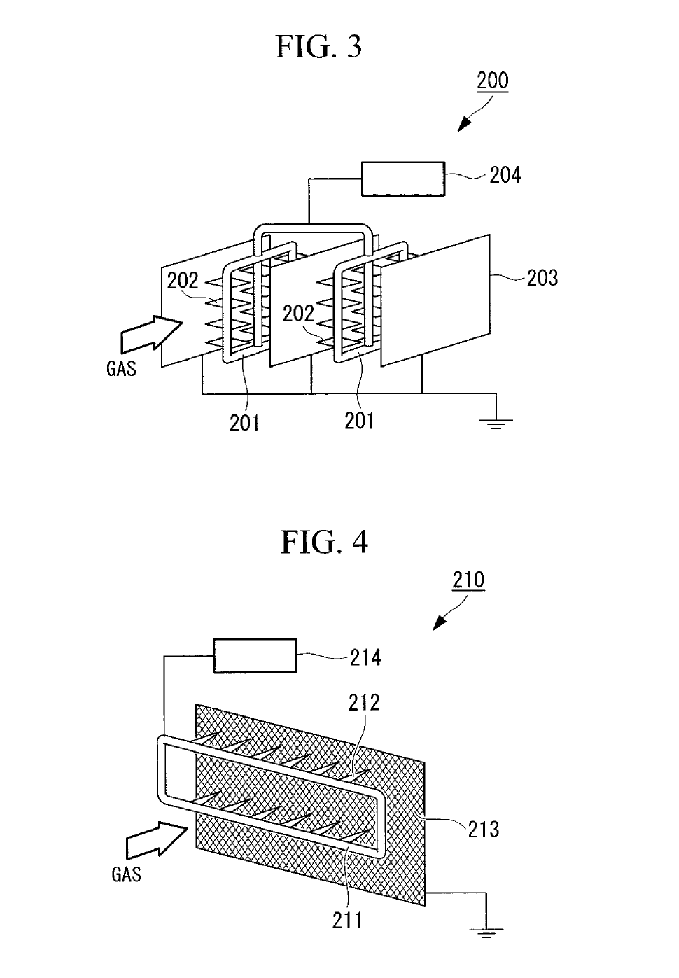

{PTL 1} Japanese Unexamined Patent Application, Publication No. Sho 60-166052 (claim 1, page 2 upper right column line 19 to lower left column line 8, page 2 lower right column lines 5 to 15, page 3 upper left column lines 5 to 10, and FIG. 3)

### SUMMARY OF INVENTION

### Technical Problem

The present invention has an object of providing a dust collection device and a method for operating the dust collection method, in which by reducing the adhesion of dust to electrodes in the pre-charging unit, and performing stable charging, dust collection can be performed with minimal pressure loss and high efficiency.

### SOLUTION TO PROBLEM

The present invention provides a method for operating a dust collection device that comprises, in a flue gas duct through which a gas flows, a pre-charging unit that charges dust within the gas, and a bag filter that collects the dust, with the pre-charging unit disposed upstream from the bag filter, the method comprising a step of charging the dust by applying a voltage to the dust from electrodes provided inside the pre-charging unit, and a step of removing the dust adhered to the electrodes by increasing the flow rate of the gas flowing through the pre-charging unit.

In the invention described above, in the step of removing the dust, the dust adhered to the electrodes can be removed by increasing the flow rate of the gas flowing through the pre-charging unit.

In the step of removing the dust, the flow rate of the gas flowing through the pre-charging unit is preferably increased by reducing the flow surface area of the gas at at least one of the gas inlet side and the gas outlet side of the pre-charging unit.

In this aspect of the present invention, in the step of removing the dust, the flow surface area of the gas is reduced by controlling the degree of opening of a gas flow path modification unit provided at the gas inlet side or the gas outlet side of the pre-charging unit.

Further, the present invention also provides a dust collection device comprising a pre-charging unit and a bag filter in a flue gas duct through which a gas flows, with the pre-charging unit disposed upstream from the bag filter, wherein the pre-charging unit comprises electrodes that charge dust within the gas, a power source that supplies electric power to the electrodes, and a gas flow rate control device that adjusts the flow rate of the gas flowing through the pre-charging unit to a prescribed value.

By charging the dust in the pre-charging unit, cohesion of the dust can be achieved, thereby facilitating trapping of the dust by the subsequent bag filter. On the other hand, dust adheres to the electrode surface during the dust charging in the pre-charging unit, forming a state that is prone to the back discharge phenomenon. In the present invention, in order to prevent this back discharge phenomenon caused by dust accumulation, the flow rate of the gas passing through the pre-charging unit is increased to scatter the dust adhered to the electrodes.

The dust collection device described above preferably comprises, a gas flow path modification unit, which is disposed at at least one of the gas inlet side and the gas outlet side of the pre-charging unit, is provided in parallel with the direction of flow of the gas, and increases or decreases the flow surface area of the gas, and a control unit which controls the gas flow surface area within the gas flow path modification unit so as to adjust the flow rate of the gas flowing through the pre-charging unit to a prescribed value.

In the present invention, the technique used for increasing the gas flow rate employs a method in which a gas flow path modification unit is provided at the gas inlet side and/or the gas outlet side of the pre-charging unit, and the degree of opening of this gas flow path modification unit is controlled. In the dust collection device of the present invention, an electrode hammering mechanism or the like is unnecessary, and the surface of the electrodes can be cleaned, thereby reliably preventing back discharge, using a simplified device configuration.

In the step of removing the dust, the flow rate of the gas is preferably increased to not less than 15 m/s.

In a typical dust collection device, the flow rate of the gas flowing through the pre-charging unit is approximately 10 to 15 m/s. By increasing the gas flow rate to not less than 15 m/s, and preferably 20 m/s or greater, dust adhered to the electrodes of the pre-charging unit can be scattered and removed.

In the step of removing the dust, the current supply from the electrodes is preferably stopped, either prior to increasing the flow rate of the gas, or during the process of increasing the flow rate of the gas. This facilitates the removal of dust from the electrodes, resulting in improved cleaning efficiency for the electrodes.

In the invention described above, in the step of charging the dust, the electrodes are preferably supplied with an alternating current, or supplied alternately with positive and negative currents. Using a boxer charger for the pre-charging unit is preferred, as it enables back discharge to be effectively prevented. A boxer charger is a device in which a unipolar charge can be applied from both sides alternately, so that for example, in an alternating current electric field, a plasma is generated at the electrodes, extracting positive or negative ions and achieving charging from both sides alternately, only when a positive or negative field is applied (see The Static Electricity Handbook, first edition, page 494).

When a boxer charger is used for the pre-charging unit, in the step of removing the dust, the superimposed excitation voltage may be set to a higher value than the excitation voltage applied in the step of charging the dust. This increases the intensity of the surface discharge generated at the electrode surface, improving the effect of shaking loose the dust adhered to the electrodes.

The step of charging the dust may include a stage of varying the voltage applied by employing on-off charging control.

Following charging of the dust for a specified time in the on-step, a portion of the charged dust adheres to the electrodes by electrostatic force. By stopping application of the voltage in the off-step, the charged dust separates more readily from the electrodes, meaning back discharge can be effectively prevented.

The on-off charging control is preferably a control technique in which an on-step of applying a voltage to the dust, and an off-step, which is performed after the on-step and involves stopping the voltage application for a period of time that is longer than the residence time of the dust in the pre-charging unit, are performed repeatedly.

By ensuring that the off-step is longer than the residence time of the dust in the pre-charging unit, the charged dust can be converted to a state that is more readily separated from the electrodes. Dust that passes through the pre-charging unit during the off-step enters the bag filter without being charged, but because charged dust has already been trapped by the bag filter, the uncharged dust is trapped via cohesion with the already trapped dust. Accordingly, there is no concern that this on-off control may contribute significantly to increased pressure loss in the bag filter.

The step of charging the dust may include a stage of stopping application of the extraction voltage, or temporarily increasing the superimposed excitation voltage.

Including this stage increases the intensity of the surface discharge generated at the electrode surface, which can shake loose the dust adhered to the electrodes, meaning back discharge can be effectively prevented.

Further, the present invention also provides a method for operating a dust collection device that comprises, in a flue gas duct through which a gas flows, a pre-charging unit that charges dust within the gas, and a bag filter that collects the dust, with the pre-charging unit disposed upstream from the bag filter, the method comprising a step of charging the dust by applying a voltage to the dust from electrodes provided inside the pre-charging unit, wherein the step of charging the dust includes a stage of varying the voltage applied by employing on-off charging control.

Following charging of the dust for a specified time in the on-step, a portion of the charged dust adheres to the electrodes by electrostatic force. By stopping application of the voltage in the off-step, the charged dust separates more readily from the electrodes, meaning back discharge can be effectively prevented.

The on-off charging control is preferably a control technique in which an on-step of applying a voltage to the dust, and an off-step, which is performed after the on-step and involves stopping the voltage application for a period of time that is longer than the residence time of the dust in the pre-charging unit, are performed repeatedly.

By ensuring that the off-step is longer than the residence time of the dust in the pre-charging unit, the charged dust can be converted to a state that is more readily separated from the electrodes. Dust that passes through the pre-charging unit during the off-step enters the bag filter without being charged, but because charged dust has already been trapped by the bag filter, the uncharged dust is trapped via cohesion with the already trapped dust. Accordingly, there is no concern that this on-off control may contribute significantly to increased pressure loss in the bag filter.

Furthermore, the present invention also provides a method for operating a dust collection device that comprises, in a flue gas duct through which a gas flows, a pre-charging unit that charges dust within the gas, and a bag filter that collects the dust, with the pre-charging unit disposed upstream from the bag filter, wherein a boxer charger is used for the pre-charging unit, the method comprises a step of charging the dust by applying a voltage to the dust from electrodes provided inside the pre-charging unit, and the step of charging the dust includes a stage of stopping application of the extraction voltage, or temporarily increasing the superimposed excitation voltage.

By superimposing an excessive excitation voltage, the intensity of the surface discharge generated at the electrode surface can be increased. As a result, dust adhered to the electrodes can be shaken loose, meaning back discharge can be effectively prevented.

### ADVANTAGEOUS EFFECTS OF INVENTION

According to the present invention, because a hammering mechanism is unnecessary, the configuration of the pre-charging unit can be simplified. Further, even when dust has adhered to the electrode surface, the back discharge phenomenon can be prevented from occurring, and charging of the dust can be performed with good efficiency.

### BRIEF DESCRIPTION OF DRAWINGS

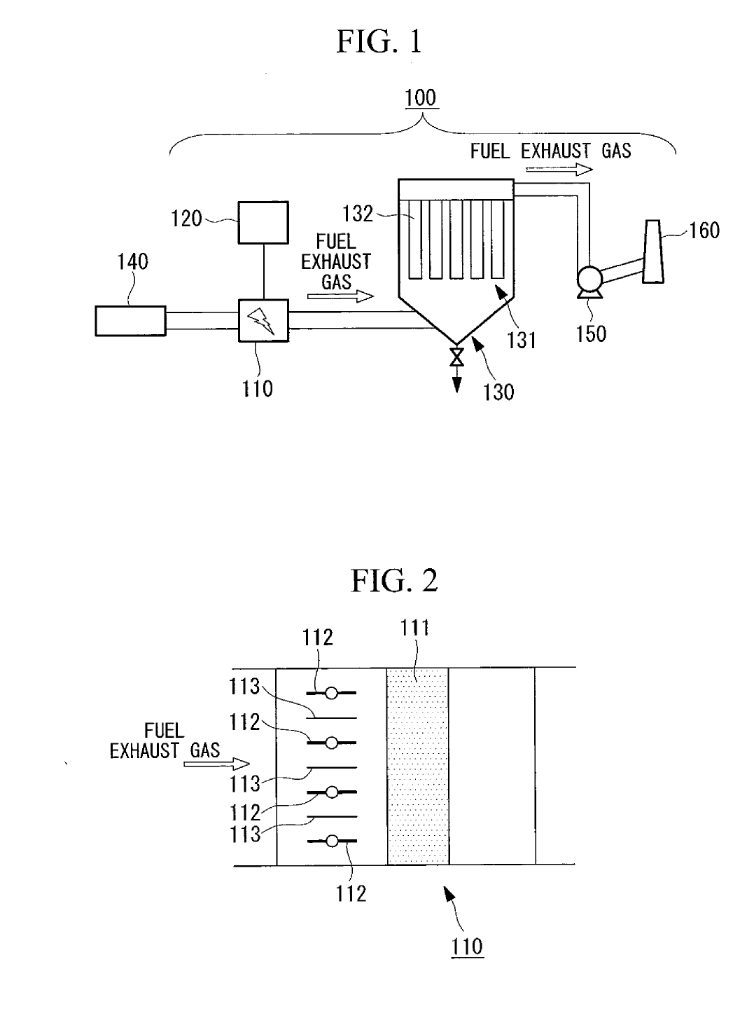

{FIG. 1} A schematic view of a dust collection device according to a first embodiment of the present invention.

{FIG. 2} A schematic view of a pre-charging unit in the dust collection device according to the first embodiment of the present invention.

{FIG. 3} A schematic view illustrating one example of the electrode structure of the pre-charging unit.

{FIG. 4} A schematic view illustrating another example of the electrode structure of the pre-charging unit.

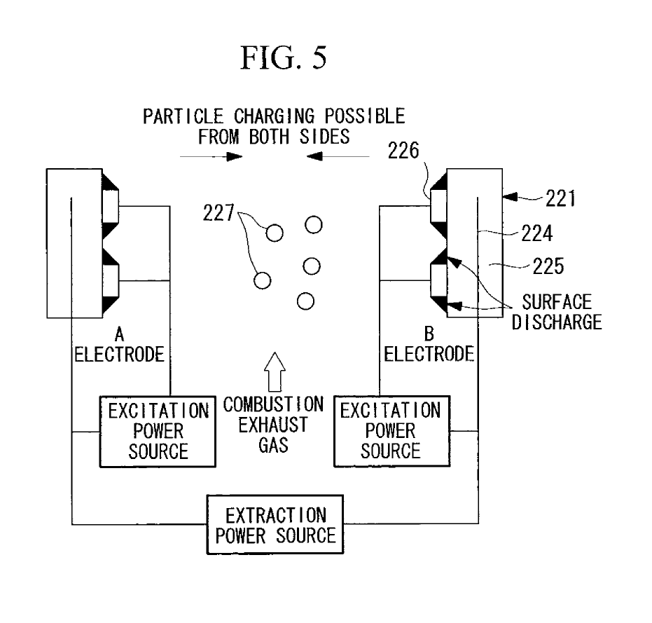

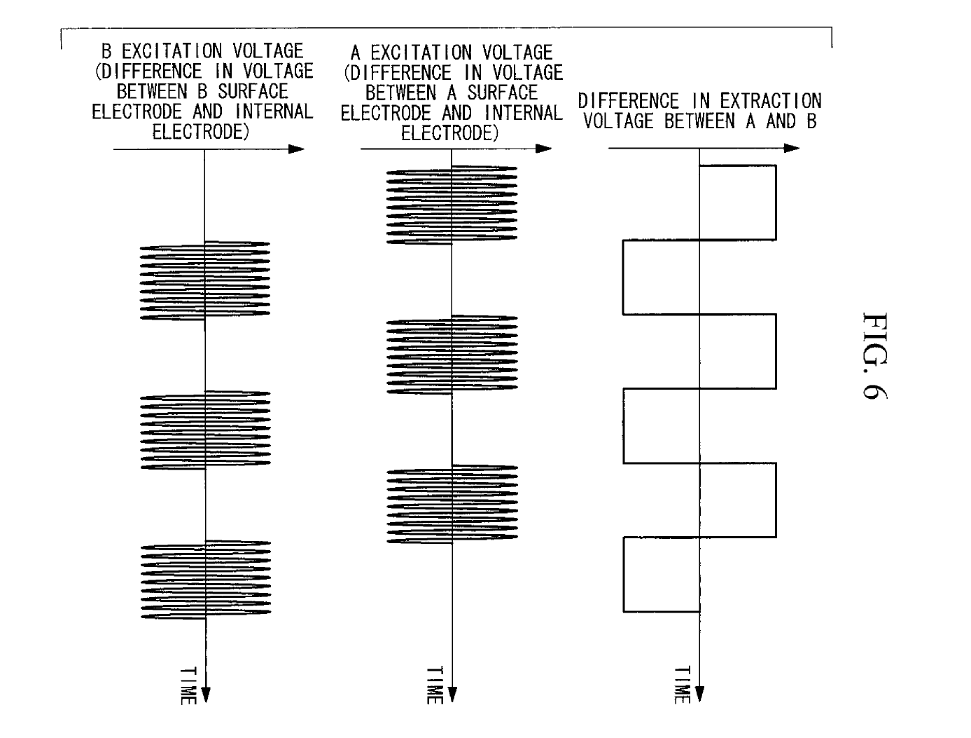

{FIG. 5} A schematic view illustrating yet another example of the electrode structure of the pre-charging unit.

{FIG. 6} A diagram illustrating examples of waveform patterns for the voltages applied to the electrodes in a boxer charger system.

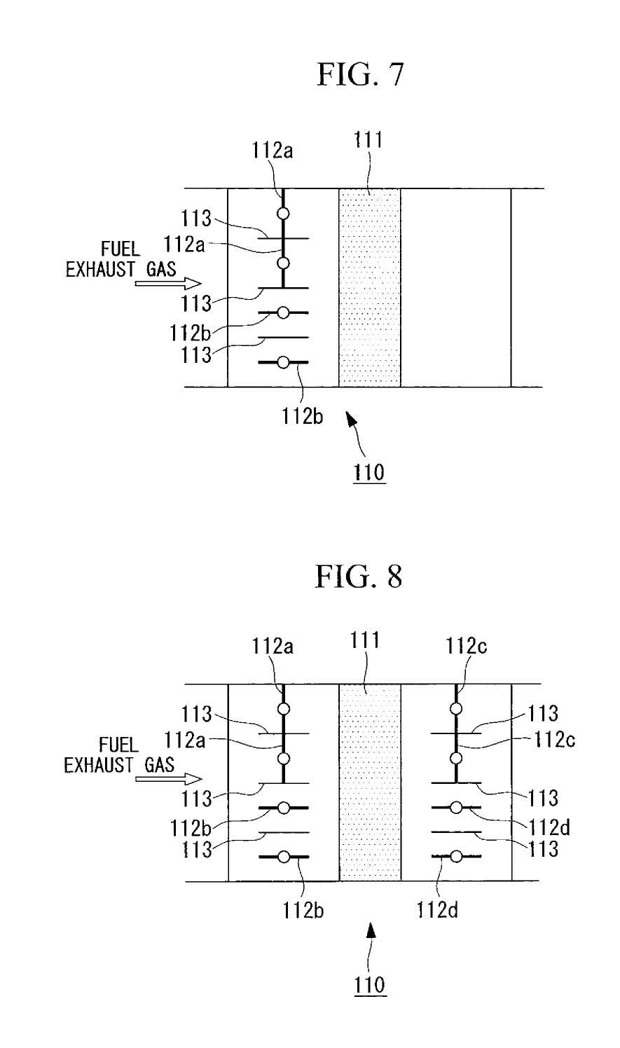

{FIG. 7} A diagram describing a method for cleaning electrodes in the case where dampers are installed at the gas inlet side of the pre-charging unit.

{FIG. 8} A diagram describing a method for cleaning electrodes in the case where dampers are installed at both the gas inlet side and the gas outlet side of the pre-charging unit.

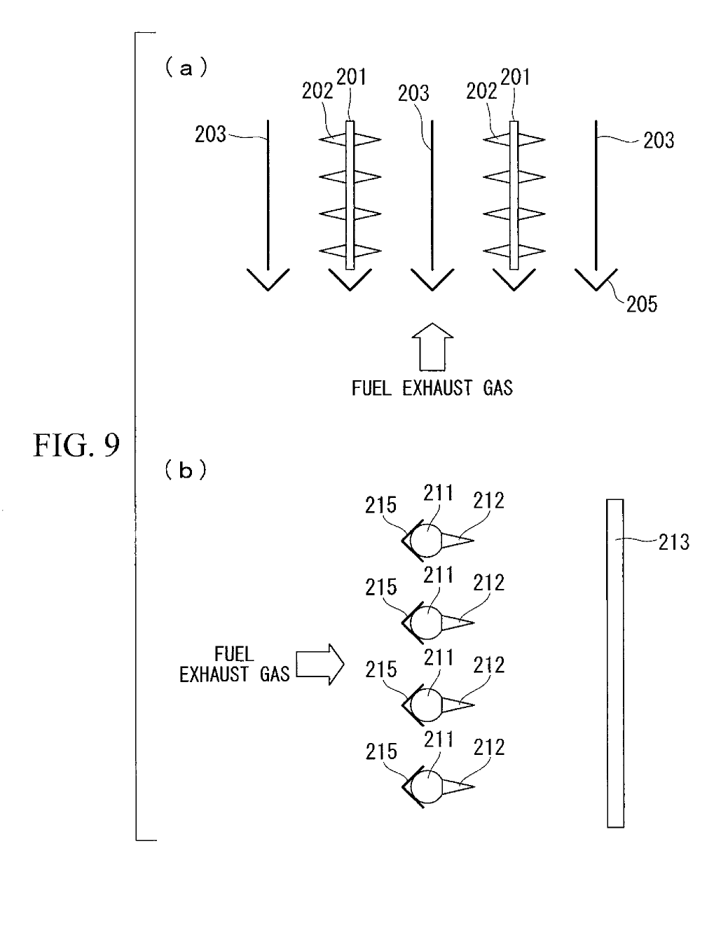

{FIG. 9} A schematic view illustrating examples in which protective members are provided on the gas flow upstream side of the electrodes inside the pre-charging unit.

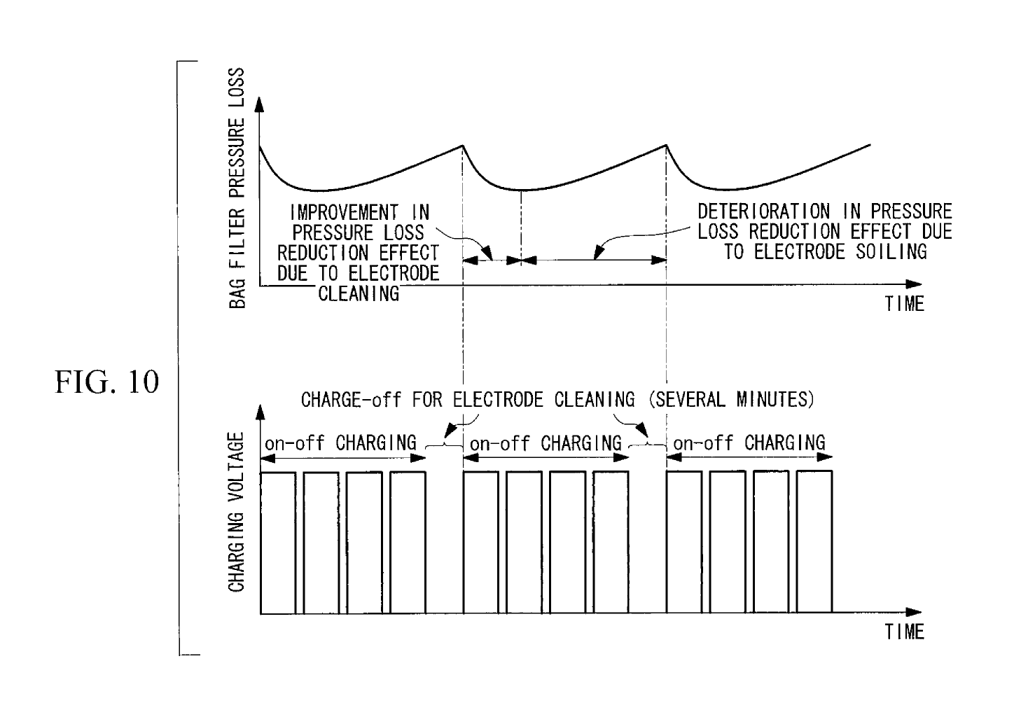

{FIG. 10} A schematic illustration of a timing chart during cleaning of one of a plurality of segments within a bag filter.

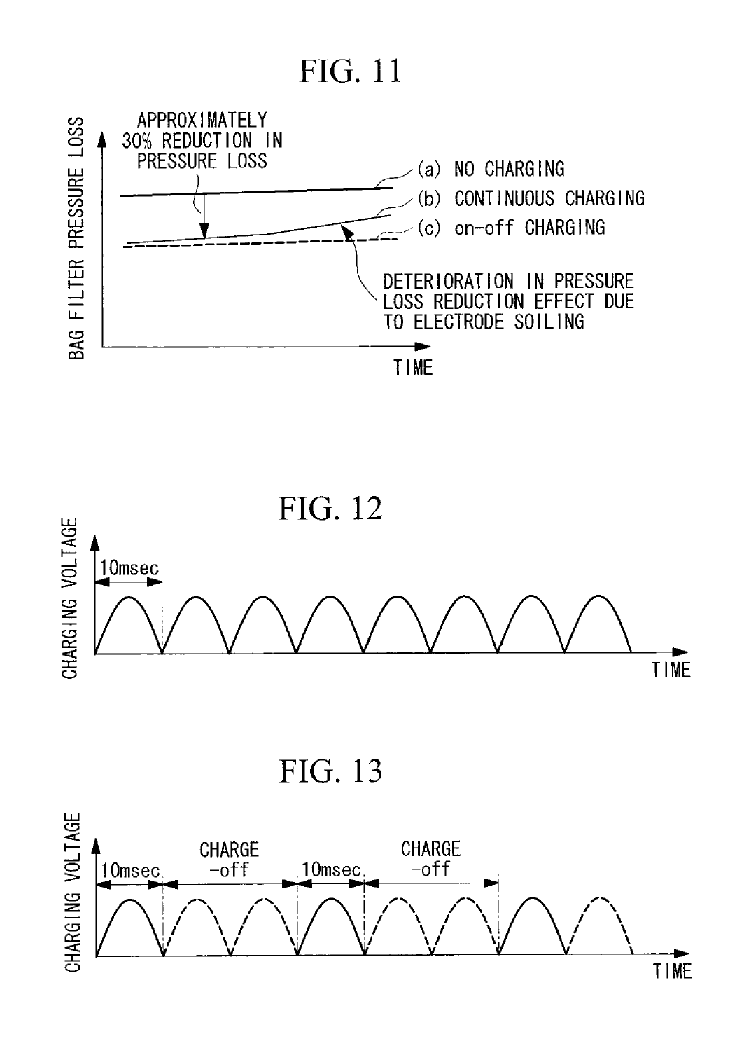

{FIG. 11} A diagram illustrating the relationship between the time and the bag filter pressure loss when employing the electrodes illustrated in FIG. 3.

{FIG. 12} A diagram illustrating the voltage waveform pattern when continuous charging is performed at a frequency of 50 Hz.

{FIG. 13} A diagram illustrating the voltage waveform pattern when intermittent charging is performed at a frequency of 50 Hz.

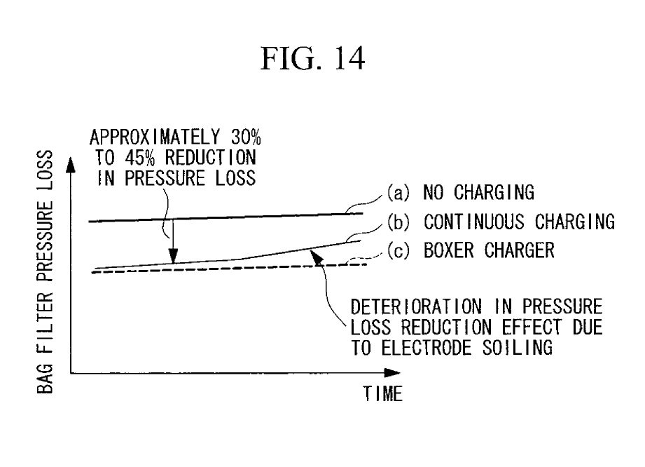

{FIG. 14} A diagram illustrating the relationship between the time and the bag filter pressure loss when employing the electrodes illustrated in FIG. 5.

### DESCRIPTION OF EMBODIMENTS

Embodiments of the dust collection device according to the present invention are described below with reference to the drawings.

### First Embodiment

FIG. 1 is a schematic view of a dust collection device according to this embodiment. A dust collection device 100 is installed in a flue gas duct positioned downstream from a boiler (combustion furnace) 140, and comprises a pre-charging unit 110 and a bag filter 130, with the pre-charging unit 110 positioned upstream from the bag filter 130. An induced draft fan 150 and a chimney 160 are disposed in a flue gas duct downstream from the bag filter 130.

FIG. 2 is a schematic view of the pre-charging unit of the dust collection device. The pre-charging unit 110 comprises an electrode section 111 thereinside. The pre-charging unit 110 also comprises a gas flow rate control device that adjusts the flow rate of the gas flowing through the pre-charging unit 110 to a prescribed value. In this embodiment, the gas flow rate control device comprises a gas flow path modification unit 112, which is provided at at least one of the gas inlet side and the gas outlet side of the pre-charging unit, and alters the flow surface area of the gas. The gas flow path modification unit 112 comprises, for example, one or more dampers. FIG. 2 illustrates an example in which a plurality of dampers are provided at the gas inlet side. In this embodiment, the plurality of dampers 112 are installed in parallel with the direction of gas flow. Partitions 113 are provided between adjacent dampers 112.

As illustrated in FIG. 1, a control unit 120 for adjusting the degree of opening of the dampers 112 is connected to the pre-charging unit 110.

FIG. 3 is a schematic view illustrating one example of the electrode section of the pre-charging unit 110 in the present embodiment. The electrode section in FIG. 3 comprises a plurality of protruding discharge electrodes 202 that are supported by a support 201, a flat plate-like grounding electrode 203, and a high-voltage power source 204 that is connected to the support 201. The high-voltage power source 204 may be an alternating current power source, or an electrode that can be switched between positive and negative polarities. As illustrated in FIG. 3, a plurality of supports 201 and grounding electrodes 203 may be provided. The tips of the discharge electrodes 202 and the grounding electrodes 203 face each other, and the supports 201 and the grounding electrodes 203 are disposed in a substantially parallel arrangement. As illustrated in FIG. 3, the combustion exhaust gas from the boiler flows through the spaces between the supports 201 and the grounding electrodes 203.

FIG. 4 illustrates another example of the electrode section of the pre-charging unit 110. The electrode section in FIG. 4 comprises a plurality of protruding discharge electrodes 212 supported by a support 211, a grounding electrode 213 having a plurality of holes, and a high-voltage power source 214 connected to the support 211. The high-voltage power source 214 may be an alternating current power source, or an electrode that can be switched between positive and negative polarities. The grounding electrode 213 may be formed from wire netting or punched metal or the like. The tips of the discharge electrodes 212 and the grounding electrode 213 face each other, and the support 211 and the grounding electrode 213 are positioned in parallel. The combustion exhaust gas from the boiler flows perpendicularly to the grounding electrode 213, and passes through the holes in the grounding electrode 213.

FIG. 5 illustrates yet another example of the electrode section of the pre-charging unit 110. The electrode section in FIG. 5 represents the electrodes of a boxer charger system. Cylindrical or flat plate-like electrodes 221 are connected to an excitation power source 222 and an extraction power source 223.

The electrodes 221 employ an insulator (such as a ceramic) 225 as a support, with an internal electrode 224 embedded inside the insulator, and a plurality of surface electrodes 226 are provided on the surface of the insulator 225 over which the gas flows.

The gas containing a dust 227 flows between the two electrodes, regardless of whether the electrodes are cylindrical electrodes or flat plate-like electrodes.

The bag filter 130 contains a filter cloth 132 for trapping the dust within the gas inside a dust chamber 131. An upper space is provided in the upper portion of the dust chamber 131, and is separated from the dust chamber 131 via an upper wall of the dust chamber 131 and the filter cloth 132. The dust chamber 131 is connected to the pre-charging unit 110 via a flue gas duct, and the upper space is connected to the induced draft fan 150 via a flue gas duct.

A method for operating the dust collection device of the present embodiment is described below.

During normal dust collection, the control unit 120 opens the plurality of dampers 112 provided in the pre-charging unit 110. In other words, all of the plurality of dampers 112 are positioned parallel with the direction of gas flow. The flow rate of the gas introduced into the pre-charging unit 110 from the boiler 140 varies depending on the boiler load and the flow surface area of the flue gas duct, but is generally within a range from approximately 10 m/s to 15 m/s.

In those cases where electrodes illustrated in FIG. 3 or FIG. 4 are used for the pre-charging unit electrodes, during dust collection, the power source 204 or 214 supplies either a positive or negative single current (continuous charging or on-off charging) or an alternating current, or alternately supplies a positive current and a negative current, to the support 201 or 211 and the discharge electrodes 202 or 212. As a result, a corona discharge is generated between the discharge electrodes 202 or 212 and the grounding electrode 203 or 213, thereby charging and causing cohesion of the dust contained within the gas flowing between the discharge electrodes 202 or 212 and the grounding electrode 203 or 213.

When electrodes of the boxer charger system illustrated in FIG. 5 are used, a high-frequency electric field is applied as an excitation voltage between the internal electrodes 224 and the surface electrodes 226. At this time, a surface discharge is generated on the surface of the insulator (such as a ceramic) 225 around the surface electrodes 226. As the excitation voltage is increased, the intensity of this surface discharge increases, thus improving the effect of shaking loose any adhered dust. By using the alternating current electric field produced by the extraction power source applied between the internal electrodes 224, the positive ions or negative ions within the plasma generated by the surface discharge are mutually attracted toward the opposing electrode, enabling a charge to be applied from both sides alternately to the dust 227 within the gas.

FIG. 6 illustrates examples of the waveform patterns for the voltages applied to the electrodes in the boxer charger system. In this figure, the horizontal axis represents the time, and the vertical axis represents the voltage. As illustrated in FIG. 6, the excitation voltage is superimposed at the surface electrodes 226.

The cohered dust then flows into the dust chamber 131 of the subsequent bag filter 130. The upper space inside the bag filter 130 is suctioned by the induced draft fan 150. As a result, a gas flow is generated that flows from the dust chamber 131 through the filter cloth 132 and into the upper space. Upon passage of the gas through the filter cloth 132, the dust is trapped on the external surfaces of the filter cloth 132.

As dust charging is continued, dust adheres to and accumulates on the surface of the grounding electrode 203 or 213 or the surface of the ceramic electrode 225 inside the pre-charging unit 110. This generates a state in which back discharge becomes more likely.

In the present embodiment, the electrodes inside the pre-charging unit 110 are cleaned periodically.

FIG. 7 is a diagram describing a method for cleaning the electrodes in the case where dampers are installed at the gas inlet side of the pre-charging unit. Cleaning of the electrodes can also be performed in a similar manner when dampers are installed at the gas outlet side of the pre-charging unit.

Once dust charging has been performed for a prescribed period of time, the control unit 120 closes a portion of the dampers 112a and leaves the remaining dampers 112b open, as illustrated in FIG. 7. As a result, the gas flow surface area is reduced, and the flow rate of the gas flowing through the pre-charging unit 110 increases. Consequently, the dust adhered to the electrode surfaces is scattered, thus removing the dust from the electrode surfaces.

The control unit 120 can determine the positions of the dampers to be closed in accordance with those portions of the electrodes that require cleaning.

Once this electrode cleaning has been performed for a prescribed period of time, the control unit 120 opens the dampers 112a that were closed, thus finishing the electrode cleaning operation.

FIG. 8 is a diagram describing a method for cleaning the electrodes in the case where dampers are installed at both the gas inlet side and the gas outlet side of the pre-charging unit 110.

Once dust charging has been performed for a prescribed period of time, the control unit 120 closes a portion of the dampers 112a at the gas inlet side and a portion of the dampers 112c at the gas outlet side. The remaining dampers 112b at the inlet side and the remaining dampers 112c at the outlet side are left open. This step enables the dust adhered to the electrode surfaces to be removed. Once this electrode cleaning has been performed for a prescribed period of time, the control unit 120 opens the dampers 112a and 112c that were closed, thus finishing the electrode cleaning operation.

In order to enable effective removal of the dust from the electrode surfaces, the flow rate of the gas flowing through the pre-charging unit 110 during the electrode cleaning operation is typically not less than 15 m/s, and preferably 20 m/s or greater. The control unit 120 determines the degree of opening of the dampers, namely the number of dampers to be closed, so as to achieve a flow rate of not less than 15 m/s (and preferably 20 m/s or greater).

When the flow rate of the gas flowing through the pre-charging unit during cleaning exceeds 10 m/s, there is a danger that the electrode materials may suffer abrasion. In order to prevent such abrasion, the electrodes may be produced from materials having excellent abrasion resistance. Specifically, the electrode materials are preferably abrasion-resistant materials such as tempered steel materials (such as S45C, SUS420J1 and SCM435), chilled cast iron, high-chromium cast iron, and hardened chrome-plated materials.

Alternatively, a protective member having excellent abrasion resistance may be provided on the gas upstream side of each of the electrodes. Examples of materials that may be used for this protective member include inexpensive materials such as SS400 and FC25, or other abrasion-resistant materials such as tempered steel materials, chilled cast iron, high-chromium cast iron, and hardened chrome-plated materials. FIG. 9(a) illustrates an example in which protective members are installed for the electrodes of FIG. 3, wherein a protective member 205 is provided on the gas upstream side of each of the supports 201 and each of the grounding electrodes 203. FIG. 9(b) illustrates an example in which a protective members 215 is provided on the gas upstream side of each of the supports 211 (discharge electrodes) of FIG. 4. There are no particular limitations on the shape of the protective members 205 and 215, provided they are capable of preventing abrasion of the electrodes caused by the gas flow containing the dust hitting the electrodes at high speed (of 10 m/s or greater).

According to the present embodiment, dust is charged in the pre-charging unit and the charged dust is collected in the bag filter, and by using a simple configuration to increase the flow rate of the gas flowing through the pre-charging unit, dust adhered to the electrodes of the pre-charging unit can be shaken loose and removed. In the present embodiment, dampers were used to reduce the flow surface area, but the present invention is not limited to this configuration, and for example, an air nozzle or the like may be installed upstream from the pre-charging unit and used to increase the flow rate.

### Second Embodiment

Next is a description of a second embodiment.

If discharge is continued during the electrode cleaning operation described above, then because the dust is charged, removal of the dust from the electrode surfaces becomes difficult. Accordingly, in this embodiment, either prior to the commencement of electrode cleaning (namely, closing of the dampers) or during the electrode cleaning, the control unit 120 may stop the current supply from the power source to the discharge electrodes, or to the internal electrodes and the surface electrodes, thereby stopping the discharge. In this case, during the period while the cleaning is performed, the dust passing through the pre-charging unit 110 does not undergo charging and cohesion, but rather flows into the dust chamber 131 of the subsequent bag filter 130 in a state that still includes very fine dust. Because dust that has previously undergone charging and cohesion is already trapped on the filter cloth 132, the uncharged dust is trapped via cohesion with the already trapped dust. In order to ensure satisfactory removal of the dust, the current supply is preferably stopped for the majority of the period during which the gas flow rate is increased.

In a dust collection device that employs a boxer charger as the pre-charging unit, when operation was performed for several hours with the gas supplied at a flow rate within a range from 10 to 15 m/s, dust adhered to and covered the electrode surfaces. Subsequently, in this dust-adhered state, the current supply from the electrode was stopped, and the dust collection device was operated for several minutes with the gas containing the dust supplied to the pre-charging unit at a flow rate within a range from 15 to 30 m/s. As a result, it was confirmed visually that the majority of the dust adhered to the electrodes inside the pre-charging unit had been removed. These results confirm that increasing the flow rate of the gas flowing through the pre-charging unit has the effect of removing adhered dust from the electrodes. Further, it was also confirmed that by stopping the current supply, the adhered dust could be removed more effectively.

FIG. 10 is a schematic illustration of a timing chart during cleaning of one of a plurality of segments within a bag filter. In this figure, the horizontal axis represents the time, the vertical axis (in the upper figure) represents the bag filter pressure loss, and the vertical axis (in the lower figure) represents the charging voltage. The electrode configuration illustrated in FIG. 3 was employed. Dampers were installed at the gas inlet side of the pre-charging unit, and the volume of gas introduced into the bag filter was kept constant. In the step of charging the dust, on-off charging control was used to vary the voltage applied. Following execution of the step of charging the dust for a prescribed period of time, the current supply was stopped, and the step of removing the dust adhered to the electrodes was performed. The above two steps were designated as a single cycle, and this cycle was performed repeatedly. As illustrated in FIG. 10, by cleaning the electrodes in the step of removing the dust adhered to the electrodes, back discharge was prevented, and an improvement was observed in the bag filter pressure loss reduction effect.

During operation of the dust collection device, when the flow rate through the pre-charging unit was set to 10 to 15 m/s, the pressure loss exhibited an upward trend once charging was started. In this state, the flow rate through the pre-charging unit was increased to a value within a range from 15 to 20 m/s, and cleaning of the electrodes was performed. Following cleaning, the bag filter pressure loss was approximately 4 to 20% lower than that prior to cleaning. Further, when the flow rate through the pre-charging unit was increased to a value within a range from 20 to 30 m/s, the bag filter pressure loss was reduced by approximately 7 to 23% compared with that prior to cleaning.

The above results confirmed that by increasing the gas flow rate, and also stopping the current supply by using on-off charging, or stopping the extraction voltage in the case of a boxer charger, the dust adhered to the electrodes in the pre-charging unit could be removed efficiently, thereby efficiently inhibiting pressure loss, and enabling the dust collection device to be operated in a stable manner.

In those cases where electrodes of a boxer charger system are employed in the pre-charging unit 110, then during the operation for cleaning the electrodes, instead of stopping the current supply in the manner described above, the superimposed excitation voltage may be increased to a value greater than that used during dust charging. By increasing the excitation voltage, the intensity of the surface discharge increases, which enhances the effect whereby the dust adhered to the electrodes is shaken loose.

### Third Embodiment

In this embodiment, the difference in pressure loss achieved by performing charging control in the pre-charging unit is described. This embodiment is applied to both a dust collection device that employs the step of removing dust by increasing the gas flow rate, as described in the first and second embodiments, and a dust collection device that does not employ the dust removal step. With the exception that the mechanism for increasing the flow rate is optional, the structures of the devices are the same as those described above.

First is a description of the differences between no charging, continuous charging, and on-off charging control.

FIG. 11 is a comparative diagram which compares, for a device that employs the electrode configuration illustrated in FIG. 3 and uses the pre-charging unit to charge the dust, the case (c) in which the voltage is varied by using on-off charging control, and the cases (a and b) in which no charging or continuous charging respectively is performed. As illustrated in FIG. 11, with no charging, the pressure loss tends to remain high, whereas with continuous charging, although a reduction in the pressure loss is achieved compared with the case of no charging, the pressure loss tends to rise as time elapses. On the other hand, in the case of on-off charging control, although the pressure loss eventually increases, the upward trend in the pressure loss is more moderate than that observed for continuous charging, confirming that for a dust collection device that comprises a pre-charging unit upstream from the bag filter, on-off charging control is effective.

By using on-off charging control, any increase in the pressure loss can be suppressed for a longer period than that achievable using continuous charging.

On-off charging control may be performed by repeating an on-step of applying a voltage to the dust, and an off-step, performed following the on-step, of stopping application of the voltage for a period of time that is longer than the residence time of the dust inside the pre-charging unit.

By providing an off-step in which the voltage is stopped for a period of time that is longer than the residence time of the dust inside the pre-charging unit, the charge accumulated on the dust that has adhered to and accumulated on the electrode surfaces can be reset more effectively. As a result, back discharge can be effectively prevented.

Assuming that the dust is fly ash, investigation of the length of the charge-off time (relaxation time constant) required to relax the accumulated charge on the dust adhered to and accumulated on the electrode surfaces, thus preventing back discharge, revealed that, even when differences in physical properties were taken into consideration, an off-step of approximately 3 seconds in the step of charging the dust was sufficient to reset the accumulated charge. Accordingly, using a time of approximately 3 seconds as a guideline, the length of time of the off-step may be set appropriately in accordance with the physical properties of the dust that represents the target of the dust collection.

For example, when the flow rate inside the pre-charging unit is 15 m/s and the length of the pre-charging unit is 0.5 m, the residence time inside the pre-charging unit is approximately 0.03 seconds. Accordingly, the off-step time is greater than the residence time. During the off-step timing, totally uncharged dust is introduced into the subsequent bag filter 130. Because charged dust has already been trapped by the filter cloth, the uncharged dust is trapped via cohesion with the already trapped dust. Accordingly, even when an off-step that is longer than the dust residence time is provided, a pressure loss reduction effect can still be achieved for the bag filter 130.

In an electric dust collection device (or electrostatic precipitator (EP)), a charging control technique called intermittent charging is already known. Intermittent charging is a control method in which a charge-off time is provided with the premise that all dust inside the EP still undergoes charging. The dust residence time inside the EP is typically within a range from several seconds to several tens of seconds. For example, as illustrated in FIG. 12, when continuous charging is performed at a frequency of 50 Hz, a single charge time is 10 msec. Consequently, in order to ensure that all the dust that passes through the pre-charging unit is charged, intermittent charging such as that illustrated in FIG. 13 (⅓ charging, charge-off time: 20 msec) must be employed. In other words, the charge-off time in intermittent charging must be in the order of several tens of msec to several hundred msec. Accordingly, in an intermittent charging system, the residence time is greater than the charge-off time, and therefore it is impossible to obtain a charge reset effect similar to that achieved using the on-off charging control according to the present embodiment.

FIG. 14 illustrates the relationship between the time and the bag filter pressure loss for the case where the dust collection device is operated using electrodes of the boxer charger system illustrated in FIG. 5 to charge the dust in the pre-charging unit. In the case of no charging (a) and the case of normal continuous charging (b), the same trends as those described above were observed. On the other hand, by employing a boxer charger system (c) for the electrodes of the pre-charging unit, the pressure loss for the filter cloth was reduced by approximately 30% to 45%. Further, the upward trend in the pressure loss was also more moderate than that observed for typical continuous charging. This is because by using the boxer charger system for the electrodes of the pre-charging unit, particle charging is possible form both of the opposing electrodes, and as a result, dust is less likely to adhere to the electrodes, thus enabling suppression of back discharge.

In those cases where electrodes of the boxer charger system illustrated in FIG. 5 are used, superimposing an excitation voltage on the voltage applied for charging the dust is also effective. By increasing this excitation voltage, the intensity of the surface discharge increases, thereby changing the balance of the electrical adhesion forces by which the dust is adhered to the electrodes, and enabling the dust to be more easily shaken loose from the electrodes. Further, by providing a step in which the extraction voltage is turned off, a similar effect to that obtained by on-off charging can be expected.

The present invention is not limited to the removal of dust within combustion exhaust gases as described in the above embodiments, and can also be applied to the removal of dust within air.

### Reference Signs List

100 Dust collection device
110 Pre-charging unit
111 Electrode section
112 Gas flow path modification unit (damper)
113 Partition
120 Control unit
130 Bag filter
131 Dust chamber
132 Filter cloth
140 Boiler
150 Induced draft fan
160 Chimney

1. A method for operating a dust collection device comprising, in a flue gas duct through which a gas flows, a pre-charging unit that charges a dust within the gas, and a bag filter that collects the dust, with the pre-charging unit disposed upstream from the bag filter, the method comprising:
a step of charging the dust by applying a voltage to the dust from electrodes provided inside the pre-charging unit, and
a step of removing the dust adhered to the electrodes by increasing a flow rate of the gas flowing through the pre-charging unit.

2. The method for operating a dust collection device according to claim 1, wherein
in the step of removing the dust, a flow rate of the gas flowing through the pre-charging unit is increased by reducing a flow surface area of the gas at at least one of a gas inlet side and a gas outlet side of the pre-charging unit.

3. The method for operating a dust collection device according to claim 1, wherein a flow rate of the gas is increased to not less than 15 m/s in the step of removing the dust.

4. The method for operating a dust collection device according to claim 2, wherein in the step of removing the dust, the flow surface area of the gas is reduced by controlling a degree of opening of a gas flow path modification unit provided at the gas inlet side and/or the gas outlet side of the pre-charging unit.

5. The method for operating a dust collection device according to claim 1, wherein in the step of removing the dust, current supply from the electrodes is stopped, either prior to increasing the flow rate of the gas or during a process of increasing the flow rate of the gas.

6. The method for operating a dust collection device according to claim 1, wherein in the step of charging the dust, the electrodes are supplied with an alternating current, or supplied alternately with positive and negative currents.

7. The method for operating a dust collection device according to claim 1, wherein
a boxer charger is used for the pre-charging unit, and
in the step of removing the dust, a superimposed excitation voltage is set to a higher value than an excitation voltage applied in the step of charging the dust.

8. The method for operating a dust collection device according to claim 1, wherein the step of charging the dust comprises a stage of varying the voltage applied by employing on-off charging control.

9. The method for operating a dust collection device according to claim 8, wherein the on-off charging control is a control technique in which an on-step of applying a voltage to the dust, and an off-step, which is performed after the on-step and comprises stopping application of the voltage for a period of time that is longer than a residence time of the dust in the pre-charging unit, are performed repeatedly.

10. The method for operating a dust collection device according to claim 7, wherein the step of charging the dust comprises a stage of stopping application of an extraction voltage, or temporarily increasing a superimposed excitation voltage.

11. A dust collection device comprising a pre-charging unit and a bag filter in a flue gas duct through which a gas flows, with the pre-charging unit disposed upstream from the bag filter, wherein the pre-charging unit comprises:
electrodes that charge a dust within the gas,
a power source that supplies electric power to the electrode, and
a gas flow rate control device that adjusts a flow rate of the gas flowing through the pre-charging unit to a prescribed value.

12. The dust collection device according to claim 11, wherein the gas flow rate control device comprises:
a gas flow path modification unit, which is disposed at at least one of a gas inlet side and a gas outlet side of the pre-charging unit, is provided in parallel with a direction of flow of the gas, and increases or decreases a flow surface area of the gas, and
a control unit which controls the gas flow surface area within the gas flow path modification unit so as to adjust a flow rate of the gas flowing through the pre-charging unit to a prescribed value.

13. The dust collection device according to claim 11, wherein the power source is an alternating current power source, or a power source that alternately supplies positive and negative currents.

14. The dust collection device according to claim 11, wherein the pre-charging unit is a boxer charger.

15. A method for operating a dust collection device comprising, in a flue gas duct through which a gas flows, a pre-charging unit that charges a dust within the gas, and a bag filter that collects the dust, with the pre-charging unit disposed upstream from the bag filter, the method comprising:
a step of charging the dust by applying a voltage to the dust from electrodes provided inside the pre-charging unit, wherein
the step of charging the dust comprises a stage of varying the voltage applied by employing on-off charging control.

16. The method for operating a dust collection device according to claim 15, wherein
the on-off charging control is a control technique in which an on-step of applying a voltage to the dust, and an off-step, which is performed after the on-step and comprises stopping application of the voltage for a period of time that is longer than a residence time of the dust in the pre-charging unit, are performed repeatedly.

17. A method for operating a dust collection device comprising, in a flue gas duct through which a gas flows, a pre-charging unit that charges a dust within the gas, and a bag filter that collects the dust, with the pre-charging unit disposed upstream from the bag filter, wherein
a boxer charger is used for the pre-charging unit,
the method comprises a step of charging the dust by applying a voltage to the dust from electrodes provided inside the pre-charging unit, and
the step of charging the dust comprises a stage of stopping application of an extraction voltage, or temporarily increasing a superimposed excitation voltage.
